(19) United States
(12) Patent Application Publication
(10) Pub. No.: US 2025/0298717 A1
(43) Pub. Date: Sep. 25, 2025

(54) DEEP LEARNING DATA COMPRESSION USING MULTIPLE HARDWARE ACCELERATOR ARCHITECTURES

(71) Applicant: Maxeler Technologies LTD., London (GB)

(72) Inventors: Peter Hicks, London (GB); Tobias Becker, London (GB); Uros Stojcic, Belgrade (RS)

(21) Appl. No.: 18/611,228

(22) Filed: Mar. 20, 2024

(51) Int. Cl. G06F 11/34

(52) U.S. Cl. CPC G06F 11/3442

(57) ABSTRACT

Deep learning data compression using multiple hardware accelerator architectures is provided herein. A system includes a computing device and first and second hardware accelerators coupled thereto. The first and second hardware accelerators may be of different types, such as a tensor streaming processor and a field programmable gate array. The first and second hardware accelerators may be directly connected to one another, such as by a chip-to-chip connection. The first and second accelerators may implement different stages of a data pipeline, such as lossless and lossy compression stages of a learned image compression.

### FIELD OF THE INVENTION

This invention relates to a system, process, and other embodiments for data compression.

### BACKGROUND OF THE INVENTION

Artificial Intelligence (AI) models have gained significant attention and have found commercial applications in various fields, including natural language processing, computer vision, robotics, healthcare, finance, and more. Such models have revolutionized tasks that were traditionally difficult for computers or graphic processor units (GPUs) to perform and have opened new possibilities for automation, intelligent decision-making, and problem-solving. AI models may include machine learning models that are trained on data to learn patterns and make predictions or decisions. These AI models can be categorized into various types, including large language models (LLM), supervised learning models, unsupervised learning models, and neural networks. These AI models are often used in demanding applications that push existing processor chips to their operational limits causing the models to execute slowly or inefficiently. This is particularly true for latency critical applications such as speech, image, or video processing.

### SUMMARY OF THE INVENTION

In one aspect of the invention, a system includes a computing device and a first hardware accelerator coupled to the computing device. The first hardware accelerator is programmed to accelerate performance of a first stage of a data processing pipeline with respect to input data received from the computing device. The input data may be stored data or a stream of data received from a speech, image, or video processing sensor or generator.

A second hardware accelerator is coupled to the computing device and programmed to accelerate performance of a second stage of the data processing pipeline. The second hardware accelerator is also coupled directly to the first hardware accelerator and is configured to receive intermediate data of the data processing pipeline directly from the first hardware accelerator in bypass of the computing device. The second hardware accelerator is further configured to transfer final data resulting from the second hardware accelerator to the computing device by way of low latency communication path. An aspect is that both accelerators are directly connected via Chip-to-Chip (C2C). Data could be received by the first accelerator directly from an external source, without restriction of flow.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 illustrates an example, non-limiting, schematic block diagram of a system comprising hardware accelerators of different types in accordance with an embodiment;

FIG. 2 illustrates an example, non-limiting, process flow diagram of a computer-implemented method for processing data using hardware accelerators of different types in accordance with an embodiment;

FIG. 3 illustrates an example, non-limiting, schematic block diagram of a system comprising hardware accelerators of different types configured to perform compression in accordance with an embodiment;

FIG. 4A illustrates an example, non-limiting, process flow diagram of a computer-implemented method for compressing data in accordance with an embodiment;

FIG. 4B illustrates an example, non-limiting, process flow diagram of a computer-implemented method for decompressing data in accordance with an embodiment;

FIG. 5A illustrates another example, non-limiting, schematic block diagram of a system comprising hardware accelerators of different types configured for an autoregressive large language models suitable for various natural language processing tasks, such as text generation, machine translation, and conversational artificial intelligence;

FIG. 5B illustrates yet another example, non-limiting, schematic block diagram of a system for accelerating traditional image decompression methods such as JPEG on an FPGA and passing the decompressed image to a second accelerator for artificial intelligence analysis; and

FIG. 6 illustrates a schematic block diagram of an example, non-limiting, computing device suitable for implementing methods in accordance with embodiments according to the disclosure.

### DETAILED DESCRIPTION

A learned image compression (LIC) model can be created from a combined learned lossy compression/decompression model and a classical entropy coder. The LIC model can be implemented as a single pipeline that takes an image, audio or video as input and produces a reconstructed output of the image (audio or video) at the output of the accelerator. The input image is passed through a machine learning lossy compression algorithm.

A machine learning lossy compression algorithm is a type of data compression technique that uses machine learning algorithms to reduce the size of a dataset while still maintaining an acceptable level of quality. Lossy compression algorithms work by removing some of the data from the original dataset, which can result in a loss of information. However, by carefully selecting which data to remove, it is possible to significantly reduce the size of the dataset while still maintaining the overall quality of the data. One example of a machine learning lossy compression algorithm is referred to as “deep image compression,” which uses deep neural networks to compress images. This technique works by training a deep neural network to identify and remove redundant information in an image, while still maintaining the overall quality of the image.

In an embodiment, a lossy compression algorithm such as described in a paper https://arxiv.org/abs/1802.01436 (“Variational image compression with a scale hyperprior,” by Johannes Ballé et al.) can be utilized and is incorporated by reference herein in its entirety.

The output of the machine learning compression model is a lossily compressed latent state, with the fully compressed output generated by passing this latent state through the lossless entropy coding model that finds a minimal representation of the already lossily compressed data. The term “latent state” refers to a set of internal variables or parameters that are used by the machine learning compression model to represent the input data. These internal variables or parameters are not directly observable, but they are used to generate the output of the model. The final step in the compression process is to pass the latent state through a lossless entropy coding model. This model finds a minimal representation of the already lossily compressed data, which can be used to further reduce the size of the compressed image. Additionally, the lossy model(s) are trained such that the latent state can be maximally compressed by the entropy coder. By way of example the learning algorithm used to train the model might have a loss function “L” where “L” is a function of quality and smallness of final output e.g., L=f (quality of output, smallness of compressed state).

In an embodiment, entropy coders are used in data compression to encode data in a way that takes advantage of statistical redundancies in the data. A classical entropy coder is a type of entropy coder that uses a fixed probability model to encode the data. Huffman coding is a classical entropy coding technique that uses a variable-length code to represent each symbol in the data. The length of the code for each symbol is determined by the frequency of occurrence of the symbol in the data. Symbols that occur more frequently are assigned shorter codes, while symbols that occur less frequently are assigned longer codes. Arithmetic coding is another classical entropy coding technique that uses a single interval to represent the entire data set. Each symbol in the data is assigned a subinterval within the overall interval, based on the probability of the symbol. The subintervals are then combined to form a single interval, which can be represented using a fixed-length code. The entropy coder is used to further compress the output of the learned compression model, which can help to reduce the overall size of the compressed data.

The associated decoder model includes an entropy decoder model and a machine learning (ML) decoder. The entropy decoder model is essentially the reverse of the entropy encoder and reproduces the lossily compressed state. The ML decoder model is a model trained to reconstruct an image as best as possible from the lossily compressed latent state.

Successful attempts have been made to map the machine learning encoder and decoder onto graphic cards or tensor streaming processors (TSP). However, the entire algorithm including entropy coding was commercially unsuccessful because entropy models are typically serialized operating on a sequence of data, they do not map well (e.g., efficiently) to the highly parallel architectures suited for machine learning tasks. In practice, an uncompressed image would be sent to the graphic card or TSP for lossy compression, and the latent representation subsequently returned to a host CPU for entropy coding. Unfortunately, this approach fails because the CPU bottlenecks the processing pipeline, with the CPU-based entropy model being unable to keep up with the machine learning compression implemented on the graphic card or TSP. Additionally, there is an overhead of transferring data from host (CPU) to TSP or GPU and vice-versa. Furthermore, if the output image is to be used on the accelerator (TSP or GPU) again there would involve an additional communication back to the accelerator which is doubly wasteful.

The embodiments described herein provide an improved approach for implementing LIC and/or other processes that include a machine learning stage followed by one or more other stages that would benefit from hardware acceleration.

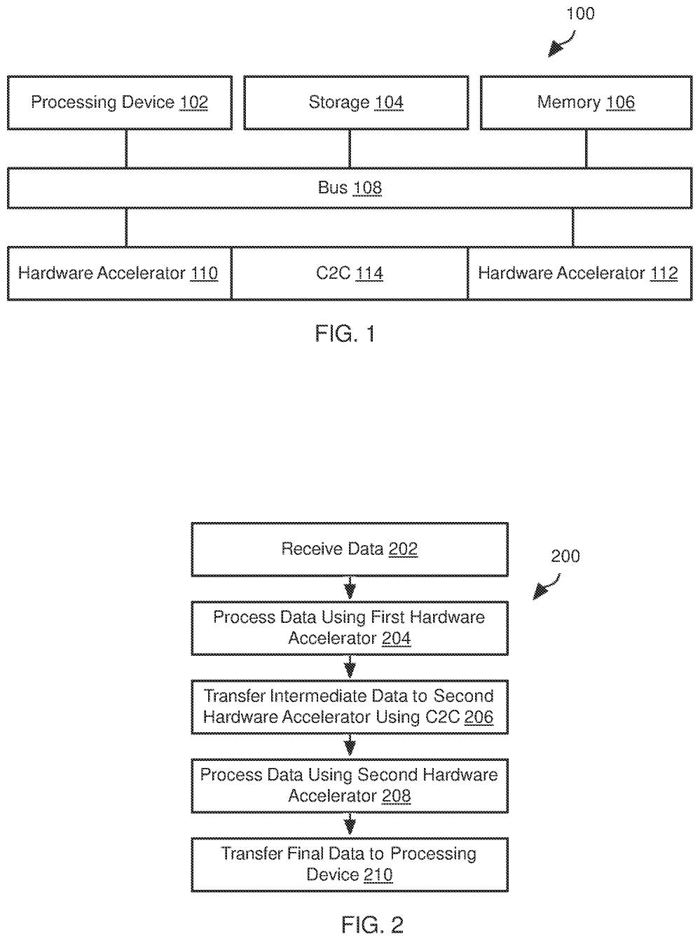

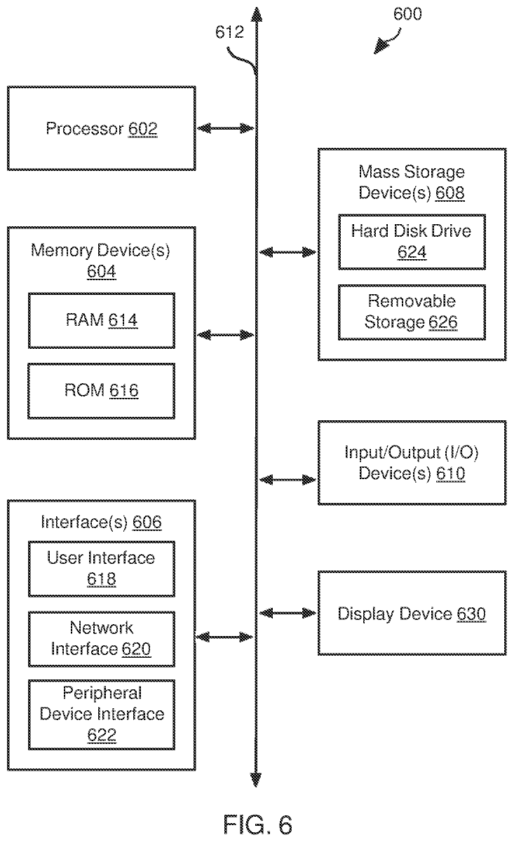

FIG. 1 illustrates an example, non-limiting, schematic block diagram of a system comprising hardware accelerators of different types in accordance with an embodiment. The system 100 includes at least one computing device 102 (e.g., one or more processing devices) and, optionally, one or more storage devices 104 and one or more memory devices 106. The computing device 102, storage device 104, and memory device 106 may be implemented as described below with respect to the example computing device 600 of FIG. 6.

The computing device 102 may be a central processing unit (CPU) and may include one or more processor cores. The computing device 102 may be part of a dedicated system providing specialized functionality such as an image processing system, audio processing system, and/or other dedicated system processing a stream of data in the form of image frames, data packets, or other types of data.

The computing device 102, storage device 104, and memory device 106 may be coupled to a bus 108, such as a peripheral component interconnect express (PCIe) bus, small component serial interface (SCSI), serial attached SCSI (SAS), serial advanced technology attachment (SATA), SAS SATA, fiber optic data bus, or other type of data bus.

The computing device 102 may be coupled to two or more hardware accelerators 110, 112. The two or more hardware accelerators may be of different types in the sense that the hardware accelerators have different hardware architectures and may be configured to accelerate processing of different types. For example, a first hardware accelerator 110 may be specialized for performing linear algebra. Linear algebra may include matrix multiplication, division, or addition or other matrix operations such as transpose, inverse, determinant, or any other matrix operation. A second hardware accelerator 112 may be configured to perform sequential operations, for example, any mathematical or binary operation, a pipeline of any number of such operations in which the result of one operation is used as the input to one or more subsequent operations, or any number of pipelines, and any configuration of data exchange between any number of pipelines.

In some embodiments, the first hardware accelerator 110 is a tensor streaming processor (TSP). The TSP may be configured and programmed according to the approaches described in any of the following documents, all of which are hereby incorporated herein by reference in their entireties: U.S. Pat. No. 11,625,618, issued on Apr. 11, 2023 (filed Nov. 17, 2021) entitled PROCESSOR COMPILER and U.S. Pat. No. 11,243,880 issued on Feb. 8, 2022 (filed Sep. 14, 2018) and entitled “PROCESSOR ARCHITECTURE.” In other embodiments, the first hardware accelerator 110 is a GPU.

According to some embodiments, the second hardware accelerator 112 is a field programmable gate array (FPGA). The second hardware accelerator 112 may be some other type of hardware accelerator, digital signal processor, or other type of device.

The hardware accelerators 110, 112 are connected to the computing device 102 by the bus 108 or other interface. The hardware accelerators 110, 112 may also be connected to the storage device 104 and/or memory device 106 by the bus 108 or other interface. The hardware accelerators 110, 112 may be configured to read and/or write data directly to the storage device 104 and/or memory device 106 independently of the computing device 102.

The hardware accelerators 110, 112 may be configured to communicate with one another independently of the computing device 102 and independent of the bus 108. For example, the first hardware accelerator 110 may be coupled to the second hardware accelerator 112 via a chip-to-chip (C2C) connection 114.

In a preferred embodiment, the accelerator 110 comprises a plurality of TSPs coupled together to form a single processing device interconnected by a low latency network and the accelerator 112 comprises a plurality of FPGAs because of the large memory footprint required to implement convolutions efficiently on the TSP. The plurality of FPGAs further improves efficiently by ensuring transfer rates are capable of sustaining real time input/output.

Both hardware accelerators 110, 112 may be programmable and may be further programmed to communicate directly to one another synchronously or asynchronously. Communication may include transmitting intermediate results from one hardware accelerator 110, 112 to the other hardware accelerator 112, 110. Communication may further include transmitting control and synchronization signals between the hardware accelerators 110, 112.

FIG. 2 illustrates an example, non-limiting, process flow diagram of a computer-implemented method 200 for processing data using hardware accelerators of different types in accordance with an embodiment. The method 200 may be performed using the system 100 of FIG. 1. The method 200 includes receiving data 202, by the first hardware accelerator 110, for example, from the computing device 102. The data may have been received by the computing device 102 as a stream of data received over a network connection, images received from a camera, or images or other data retrieved from the storage device 104, and/or a sensor or from the memory device 106. The computing device 102 may pass the data to the first hardware accelerator 110 using the bus 108 or other type of connection.

The first hardware accelerator 110 processes 204 the data to obtain intermediate results. The method 200 includes transferring 206 intermediate data resulting from the processing of step 204 to the second hardware accelerator 112 over the C2C CONNECTION 114, for example, in bypass of the computing device 102. Transferring 206 the intermediate data may include transmitting control and/or synchronization signals between the hardware accelerators 110, 112. The intermediate data may be transmitted as a stream of data from the first hardware accelerator 110 to the second hardware accelerator 112, according to some implementations.

The second hardware accelerator 112 processes the intermediate data to obtain final data 208. The final data may be transferred 210, by the second hardware accelerator 112, to the computing device 102. The final data may be transferred 210 by way of the bus 108 or other connection between the second hardware accelerator 112 and the computing device 102.

The final data may be transmitted by the computing device 102 over a network connection and/or stored in the storage device 104 and/or memory device 106. The second hardware accelerator 112 may also write the final data direction to the storage device 104 and/or memory device 106 in bypass of the computing device 102.

The processing of step 204 may be a first stage of a data processing pipeline and the processing of step 208 may be a second stage of the data processing pipeline. The data processing pipeline may be a multi-stage compression and/or decompression pipeline or any other data processing pipeline that includes computations of different types that can advantageously be implemented using hardware accelerators 110, 112 of different types.

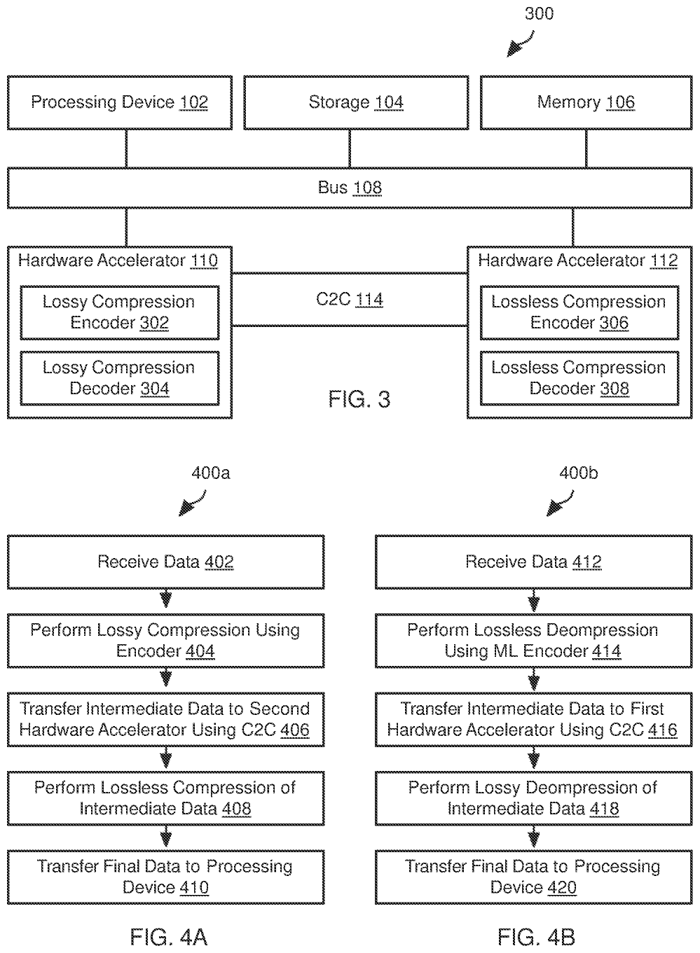

FIG. 3 illustrates an example, non-limiting, schematic block diagram of a system 300 comprising hardware accelerators of different types configured to perform compression in accordance with an embodiment. The system 300 may be implemented using system 100 of FIG. 1. The first hardware accelerator 110 may be programmed or otherwise configured to execute one or both of a lossy compression encoder 302 and a lossy compression decoder 304. The lossy compression decoder 304 is configured to decompress data compressed by the lossy compression encoder 302.

The lossy compression encoder 302 and the lossy compression decoder 304 may both be implemented as machine learning models and may, therefore, define many linear algebra operations as outlined above. For example, the lossy compression encoder 302 and the lossy compression decoder 304 may implement LIC as described above. The machine learning models may be embodied as neural networks, convolution neural networks (CNN), deep neural networks (DNN), recurrent neural networks (RNN), logistic regressions, or another type of machine learning model. The machine learning models may be placed on the hardware accelerator by compiling code defining the machine learning models and programming the first hardware accelerator 110 according to the approaches according to the documents incorporated herein by reference hereinabove.

The second hardware accelerator 112 may be programmed or otherwise configured to implement one or both of a lossless compression encoder 306 and a lossless compression decoder 308. The lossless compression decoder 308 is configured to decompress data compressed by the lossless compression encoder 306. The lossless compression encoder 306 and lossless compression decoder 308 may be configured to compress and decompress data such as images, audio data, and/or other binary data. The lossless compression encoder 306 and lossless compression decoder 308 may be configured to implement any compression algorithm and corresponding decompression algorithm, such as entropy encoding, Huffman encoding, run-length encoding (RLE), Lempel-Ziv algorithm, moving picture experts group (MPEG) compression, MP3 or later compression, or any other lossless compression algorithm.

FIG. 4A illustrates an example, non-limiting, process flow diagram of a computer-implemented method 400A for compressing data in accordance with an embodiment. The method 400A for compressing data can be implemented using the system 300 of FIG. 3. The method 400A includes receiving 402, by the lossy compression encoder 302, data to be compressed from the computing device 102, such as by way of the bus 108. The data to be compressed may be images or tiles of images. A large image may be divided into tiles by the first hardware accelerator 110 or divided into tiles by the computing device 102 with the tiles being provided to the first hardware accelerator 110 parallel or in series.

Tiles may be processed by the first hardware accelerator 110 in series or with various degrees of parallelism. In particular, the first hardware accelerator 110 performs 404 lossy compression using the lossy compression encoder 302 to obtain intermediate data. The first hardware accelerator 110 transfers 406 the intermediate data to the second hardware accelerator 112 using the C2C connection 114. A C2C (chip-to-chip) connection can be a SerDes (Serializer/Deserializer) interface, which converts serial data between high-speed serial and parallel formats for communication between integrated circuits. As described above, transferring the intermediate data may include transmitting control and synchronization signals between the first and second hardware accelerators 110, 112. In particular the transfer of intermediate data for tiles may be transmitted with control or synchronization signals to associate tiles with one another or otherwise facilitate parallel processing of tiles by the second hardware accelerator 112.

The second hardware accelerator 112 performs 408 lossless compression of the intermediate data using the lossless compression encoder 306 to obtain final data and the final data is transferred 410, by the second hardware accelerator 112, to the computing device 102, such as by way of the bus 108. The final data may also be written directly by the second hardware accelerator 112 to the storage device 104 and/or memory device 106 by way of the bus 108.

The intermediate data may be larger than the final data. The method 400A therefore has the advantage of reducing the amount of data that must be returned to the computing device 102 over the relatively slow connection to the computing device 102. Likewise, the C2C connection 114 provides a very fast and parallelized connection for exchanging the intermediate data with communication being coordinated according to the specific lossy and lossless compression algorithms implemented by the hardware accelerators 110, 112.

FIG. 4B illustrates an example, non-limiting, process flow diagram of a computer-implemented method 400B for decompressing data in accordance with an embodiment. The method 400B for decompressing data can be implemented using the system 300 of FIG. 3. The method 400B includes receiving 412, by the lossless compression decoder 308, data to be decompressed from the computing device 102, such as by way of the bus 108. The data to be decompressed may be a compressed image or compressed tiles of images. Tiles may be processed by the second hardware accelerator 112 in series or with various degrees of parallelism.

In particular, the second hardware accelerator 112 performs 414 lossless decompression using the lossless compression decoder 308 to obtain intermediate data. The second hardware accelerator 112 transfers 416 the intermediate data to the first hardware accelerator 110 using the C2C connection 114. As described above, transferring the intermediate data may include transmitting control and synchronization signals between the first and second hardware accelerators 110, 112. In particular, the transfer of intermediate data for tiles may be transmitted with control or synchronization signals to associate tiles with one another or otherwise facilitate parallel processing of tiles by the first hardware accelerator 110.

The first hardware accelerator 110 performs 418 lossy decompression of the intermediate data using the lossy compression decoder 304 to obtain final data and the final data is transferred 420, by the first hardware accelerator 110, to the computing device 102, such as by way of the bus 108. The final data may also be written directly by the first hardware accelerator 110 to the storage device 104 and/or memory device 106 by way of the bus 108.

The intermediate data may be larger than the final data. The method 400B therefore has the advantage of reducing the amount of data that must be returned to the computing device 102 over the relatively slow connection to the computing device 102. Likewise, the C2C connection 114 provides a very fast and parallelized connection for exchanging the intermediate data with communication being coordinated according to the specific lossy and lossless compression algorithms implemented by the hardware accelerators 110, 112.

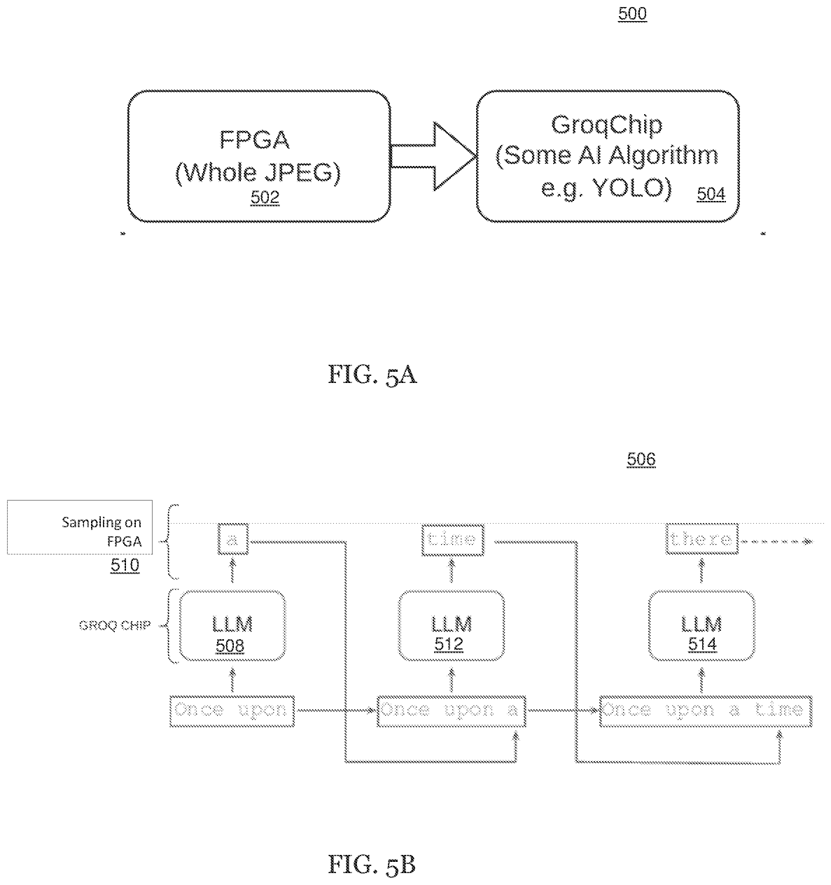

With reference now to FIG. 5A which illustrates another example, non-limiting, schematic block diagram of a system 500 comprising hardware accelerators of different types configured for an autoregressive LLM suitable for various natural language processing tasks, such as text generation, machine translation, and conversational AI.

The system 500 comprises a first accelerator 502 which, in an embodiment, is an FPGA and a second accelerator 504 which is a tensor streaming processor such as is available from Groq, Inc. In one embodiment the FPGA based accelerator 502 can be applied to various problems that involve both linear algebra and non-linear algebra components. For example, the accelerator can be used to accelerate traditional image decompression methods, such as JPEG, on the FPGA and then pass the decompressed image to an AI analysis workload executed on the second accelerator which is a tensor streaming processor such as the GroqChip™ processor, which is commercially available from Groq, Inc.

The system 500 can save on CPU resources and reduce IO, while also ensuring fully deterministic compute. The system 500 can be used for various AI algorithms such as image classification, object detection, deep learning supersampling, or other image enhancement techniques. An advantage of the system 500 is the combination of a dataflow/deterministic compute linear algebra accelerator (such as the GroqChip) and a reconfigurable dataflow/deterministic compute architecture (FPGA), which are connected with a plurality of C2C links, mitigating or eliminating the need to communicate with a host at intermediate stages of the problem. This allows for the efficient acceleration of problems that incorporate a mix of linear algebra and non-linear algebra algorithms.

In another embodiment, FIG. 5B illustrates yet another example, non-limiting, schematic block diagram of a system 506 for accelerating traditional image decompression methods such as JPEG on an FPGA and passing the decompressed image to a second accelerator for AI analysis. The system 506 can implement an autoregressive language model (LLM).

An autoregressive language model is a type of machine learning model that generates text by predicting the probability of each subsequent word or character in a sequence, based on the previous words or characters. It is referred to as “autoregressive” because it generates the sequence of words or characters one step at a time, in a sequential manner.

During inference, the model generates text by sampling from the learned probability distribution. Starting with an initial input sequence, such as a prompt or a seed sequence, the model generates the next word or character in the sequence by sampling from the distribution of possible next words or characters, conditioned on the previous sequence. The model then updates the sequence by appending the generated word or character, and repeats the process to generate the next word or character.

Autoregressive LLMs can be implemented using a variety of machine learning techniques, such as recurrent neural networks (RNNs), long short-term memory networks (LSTMs), or transformers. These techniques allow the model to learn long-range dependencies in the text, such as the relationships between words or characters that are separated by large distances in the sequence.

An advantage of autoregressive LLMs is that they can generate highly realistic and coherent text, since they are trained on large datasets of natural language text. However, they can also be computationally expensive to train and generate text from, since they require many sequential steps to generate each word or character.

The system 506 depicted in FIG. 5B, implements the autoregressive LLM with a first algorithm on the TSP which performs matrix and tensor operations required for the LLM's computations. The TSP is a specialized hardware component that is designed to perform high-performance matrix and tensor operations, such as matrix multiplication and convolution, at scale. In the context of an autoregressive LLM the matrix and tensor operations compute 508 the probability distribution over the next word or character in the sequence.

At a same time or about the same time, sampling 510 is performed on the FPGA. Sampling refers to the process of generating text by sampling from the learned probability distribution over sequences of words or characters. This is performed by generating each subsequent word or character in the sequence based on the previous words or characters, using the learned probability distribution to determine the most likely next word or character, as indicated at 512 and 514. Text generation process is performed on the FPGA for faster and more efficient text generation. Sampling is the process by which the LLM generates text by selecting the most likely next word or character in the sequence, based on the learned probability distribution. By repeating this process many times, the LLM can generate long sequences of text that are highly realistic and coherent, and that reflect the patterns and structures present in the training data. The FPGA is linked to the TSP with one or more high speed data connections (C2C) that allows data to be directly streamed from one device to another.

The TSP then performs the matrix multiplications required for the language model's computations, such as multiplying the weight matrices with the input matrices to compute the output of each layer in the model. The TSP may also apply the activation functions required for the language model's computations, such as the rectified linear unit (ReLU) or sigmoid functions. The TSP may also perform the normalization needed for the language model's computations, such as batch normalization or layer normalization. The TSP can also perform the convolution operations needed for the language model's computations, such as convolutional layers in a convolutional neural network (CNN). The TSP could also perform other matrix and tensor operations needed for the language model's computations, such as pooling, padding, or reshaping.

The TSP is a specialized hardware component that is designed to perform high-performance matrix and tensor operations required for the language model's computations.

FIG. 6 illustrates a schematic block diagram of an example, non-limiting, computing device 600 suitable for implementing methods in accordance with embodiments provided herein. The computing device 102, storage device 104, memory device 106, and bus 108 of FIG. 1 may be implemented as part of a device having some or all of the attributes of the computing device 600.

Computing device 600 includes one or more processor(s) 602, one or more memory device(s) 604, one or more interface(s) 606, one or more mass storage device(s) 608, one or more Input/Output (I/O) device(s) 610, and a display device 630 all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As depicted in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Display device 630 includes any type of device capable of displaying or rendering in another manner (e.g., outputting) information to one or more users of computing device 600. Examples of display device 630 include a monitor, display terminal, video projection device, and the like. Other examples include speakers, audio devices, tactile output, and so on.

Interface(s) 606 include various interfaces that allow computing device 600 to interact with other systems, devices, or computing environments. Example interface(s) 606 include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more peripheral interfaces such as interfaces for printers, pointing devices (mice, track pad, etc.), keyboards, and the like.

The bus 612 allows processor(s) 602, memory device(s) 604, interface(s) 606, mass storage device(s) 608, I/O device(s) 610, and display device 630 to communicate with one another, as well as other devices or components coupled to the bus 612. The bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose computing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein for the purposes of illustration, and are not intended to be limiting. Embodiments of the subject disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data computing devices, causes a device to operate as described herein.

While various embodiments of the disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teachings. Further, it should be noted that any or all of the aforementioned alternate implementations may be used in any combination desired to form additional hybrid implementations of the disclosure.

What is claimed is:

1. A system comprising:
a first hardware accelerator programmed to accelerate performance of a first stage of a data processing pipeline with respect to input data received from a computing device; and
a second hardware accelerator programmed to accelerate performance of a second stage of the data processing pipeline, the second hardware accelerator coupled directly to the first hardware accelerator and configured to receive intermediate data of the data processing pipeline directly from the first hardware accelerator, the second hardware accelerator further configured to transfer final data resulting from the second stage.

2. The system of claim 1, wherein the first hardware accelerator and the second hardware accelerator are of different types of hardware accelerators.

3. The system of claim 1, wherein the first hardware accelerator is configured to accelerate linear algebra operations as compared to the second hardware accelerator.

4. The system of claim 1, wherein the second hardware accelerator is configured to accelerate sequential processing in multiple pipelines as compared to the first hardware accelerator.

5. The system of claim 1, wherein the first hardware accelerator is a tensor streaming processor (TSP).

6. The system of claim 1, wherein the second hardware accelerator is a field programmable gate array (FPGA).

7. The system of claim 1, further comprising a computing device coupled to the first hardware accelerator and the second hardware accelerator for delivering input data and receiving output data, wherein the first hardware accelerator is a tensor streaming processor (TSP) and the second hardware accelerator is a field programmable gate array (FPGA).

8. The system of claim 1, wherein the first hardware accelerator is coupled to the second hardware accelerator via a chip-to-chip (C2C) connection.

9. The system of claim 1, wherein the first stage implements a lossy compression algorithm and the second stage implements a lossless compression algorithm.

10. The system of claim 9, wherein the lossy compression algorithm is a machine learning model.

11. The system of claim 10, wherein the lossy compression algorithm is a learned image compression (LIC) machine learning model.

12. The system of claim 9, wherein the lossless compression algorithm is an entropy encoder.

13. The system of claim 1, wherein the computing device comprises:
a computing device coupled to the computing device; and
at least one memory device, or at least one storage device, or at least one memory device and at least one storage device coupled to the computing device.

14. The system of claim 13, wherein the first hardware accelerator and the second hardware accelerator are coupled to the computing device via a data bus.

15. A method comprising:
receiving, by a first hardware accelerator and from a computing device, input data;
processing, by the first hardware accelerator, the input data to obtain intermediate data;
transmitting, by the first hardware accelerator, the intermediate data to a second hardware accelerator in bypass of the computing device;
processing, by the second hardware accelerator, the intermediate data to obtain final data; and
transmitting, by the second hardware accelerator, the final data to the computing device.

16. The method of claim 15, wherein the first hardware accelerator and the second hardware accelerator are of different types of hardware accelerators.

17. The method of claim 15, wherein:
the first hardware accelerator is configured to accelerate linear algebra operations as compared to the second hardware accelerator; and
the second hardware accelerator is configured to accelerate sequential processing in multiple pipelines as compared to the first hardware accelerator.

18. The method of claim 15, wherein the first hardware accelerator is a tensor streaming processor (TSP) and the second hardware accelerator is a field programmable gate array (FPGA).

19. The method of claim 15, wherein transmitting the intermediate data to the second hardware accelerator in bypass of the computing device comprises transmitting the intermediate data over a chip-to-chip (C2C) connection between the first hardware accelerator and the second hardware accelerator.

20. The method of claim 15, wherein processing the input data comprises implementing a learned image compression (LIC) machine learning model and processing the intermediate data comprises implementing an entropy encoding.
